(19) United States
(12) Patent Application Publication
(10) Pub. No.: US 2012/0069549 A1
(43) Pub. Date: Mar. 22, 2012

(54) HEAT-DISSIPATING STRUCTURE, BACKLIGHT MODULE, AND DISPLAY APPARATUS FOR STANDING USE

(76) Inventors: Po-Chun Hsu, Hsin-Chu (TW); Hung-Ling Yang, Hsin-Chu (TW); Chih-Wei Chang, Hsin-Chu (TW)

(21) Appl. No.: 12/972,552

(22) Filed: Dec. 20, 2010

(30) Foreign Application Priority Data
Sep. 17, 2010 (TW) 099131572

(51) Int. Cl. F21V 29/00

(52) U.S. Cl. 362/97.1

(57) ABSTRACT

A heat-dissipating structure, a backlight module, and a display apparatus for standing use are disclosed. The heat-dissipating structure includes a back plate and a heat pipe which is coupled to the back plate and includes a heat-absorbing portion at a side portion of the back plate and a heat-dissipating portion bent upward from the heat-absorbing portion to extend toward a center portion of the back plate. The backlight module includes the heat-dissipating structure, a light-guiding plate disposed above the back plate and the heat pipe, and a light source module disposed on the heat-absorbing portion at a side of the light-guiding plate. The display apparatus includes the backlight module and a panel above the light-guiding plate. Thereby, working fluid in the heat pipe can flow back to the heat-absorbing portion by use of gravity after dissipating heat at the heat-dissipating portion, which improves the whole efficiency of heat dissipation.

### BACKGROUND OF THE INVENTION

1. Field of the Invention

The invention relates to a heat-dissipating structure, and especially to a heat-dissipating structure for a backlight module.

2. Description of the Prior Art

As manufacturing technology of liquid crystal display (LCD) rapidly develops, the LCD has advantages of light weight, thickness, power saving, and less radiation so LCD is used widely in various electronic apparatuses having the need for display, such as personal digital assistants, notebook, digital cameras, digital video cameras, computer monitors, and LCD televisions. The LCD panels of the LCD apparatuses are non-self-luminous display panels, so they need light provided by backlight modules to perform displaying function.

Backlight modules are classified mainly into two groups: one is direct type; the other is edge type. A backlight module includes a back plate, a light source module, and an optical device. The back plate is used to support the light source module and the optical device. Light produced by the light source module travels into the optical device so as to produce a uniform plane light source for a LCD panel. Either the direct type backlight module or the side type backlight module needs heat dissipation, mostly through the back plate. In the direct type backlight module, its light source module usually includes a plurality fluorescent tubes disposed directly and uniformly on the optical device so that heat produced by the whole light source module is substantially uniformly distributed and the heat distribution on the back plate is also substantially uniform.

In the edge type backlight module, its light source module usually includes only signal fluorescent tube or a plurality of point light sources (e.g. light-emitting diode, LED) arranged in a line, disposed at a side of the optical device, so heat produced by the whole light source module is constrained within a relatively small area (i.e. near the side of the optical device). The heat distribution on the back plate is obviously non-uniform; furthermore, most of the heat concentrates near the area, which shows that the efficiency of the heat transfer from the light source module to the back plate is poor. For solving the uniformity of the heat distribution, a heat sink is usually used to physically connect the light source module and the back plate to transfer heat produced in operation by the light source module to the back plate. It improves the efficiency of the heat transfer between the light source module and the back plate, but for the back plate, the heat source (i.e. the portion of the heat sink connected to the back plate) still concentrates so that the heat conducted to a portion of the back plate away from the heat source is still limited. Heat absorbed by the portion of the back plate away from the heat source is therefore limited. The temperature difference induced by the absorbed heat between the portion of the back plate and the environment is also limited, the efficiency of heat dissipation of which is poor.

For this case, there is a solution using heat pipes coupled to the light source module and the back plate to rapidly transfer the heat produced by the light source module to portions of the back plate away from the light source module so as to achieve the purpose of uniformly distributing the heat on the back plate. However, based on the knowledge about using heat pipes, increasing the efficiency of heat transfer is increasing the quantity of heat pipes, so the solution needs using a lot of heat pipes, which increases cost significantly. If the quantity of the heat pipes is limited for controlling the cost, the uniformity of the heat distribution on the back plate will be reduced greatly. The improvement in the efficiency of heat dissipation is also limited. Briefly, present solutions using heat pipes for improving the heat dissipation face a choice between a significant increment of cost and a limited improvement of the efficiency of heat dissipation.

### SUMMARY OF THE INVENTION

An objective of the invention is to provide a heat-dissipating structure for standing use, so as to provide a better heat-dissipating mechanism for a light source module of a backlight module.

The heat-dissipating structure according to a preferred embodiment of the invention includes a back plate and a heat pipe. The heat pipe is coupled to the back plate and includes a heat-absorbing portion and a heat-dissipating portion. The heat-absorbing portion is disposed at a side portion of the back plate. The heat-dissipating portion is bent upward from the heat-absorbing portion to extend toward a center portion of the back plate. The light source module is disposed on the heat-absorbing portion. Working fluid in the heat pipe can absorb heat produced in operation by the light source module at the heat-absorbing portion to be a gas phase and emit the absorbed heat at the heat-dissipating portion to be a liquid phase again. The heat-dissipating structure is stood to be used, so the working fluid in the liquid phase can flow back to the heat-absorbing portion by use of gravity and a capillary structure on the inner wall of the heat pipe simultaneously for a next heat dissipation cycle. Obviously, for the heat-dissipating structure according to the invention, under a consideration to a practical use, the heat pipe is designed to be a proper structure shape coordinating with gravity such that the heat-dissipating structure according to the invention obviously has a higher efficiency of heat dissipation than that in the prior art with using the same quantity of heat pipes. Furthermore, the invention solves the difficulty in facing the choice between the increment of component cost and the limited improvement of the efficiency of heat dissipation.

Another objective of the invention is to provide a backlight module for standing use. The backlight module according to a preferred embodiment of the invention includes a light-guiding plate, a light source module, and a heat-dissipating structure. The heat-dissipating structure includes a back plate and a heat pipe. The heat pipe is coupled to the back plate and includes a heat-absorbing portion and a heat-dissipating portion. The heat-absorbing portion is disposed at a side portion of the back plate. The heat-dissipating portion is bent upward from the heat-absorbing portion to extend toward a center portion of the back plate. The light-guiding plate is disposed above the back plate and the heat pipe. The light source module is disposed on the heat-absorbing portion at a side of the light-guiding plate. Therefore, the backlight module according to the invention has the heat-dissipating mechanism of the heat-dissipating structure; in other words, the backlight module according to the invention has a higher efficiency of heat dissipation than that of a side type backlight module in the prior art, which is not to be described more.

Another objective of the invention is to provide a display apparatus. The display apparatus according to a preferred embodiment of the invention includes a base, a panel, and a backlight module. The backlight module includes a light-guiding plate, a light source module, and a heat-dissipating structure. The heat-dissipating structure includes a back plate and a heat pipe. The heat pipe is coupled to the back plate and includes a heat-absorbing portion and a heat-dissipating portion. The heat-absorbing portion is disposed at a side portion of the back plate. The heat-dissipating portion is bent upward from the heat-absorbing portion to extend toward a center portion of the back plate. The light-guiding plate is disposed above the back plate and the heat pipe. The light source module is disposed on the heat-absorbing portion at a side of the light-guiding plate. The back plate is disposed on the base. The panel is disposed above the light-guiding plate. Similarly, the display apparatus according to the invention has the heat-dissipating mechanism of the heat-dissipating structure; in other words, the display apparatus according to the invention has a higher efficiency of heat dissipation than that of a display apparatus using a side type backlight module in the prior art, which is not to be described more.

Therefore, the heat pipes of the heat-dissipating structure, the backlight module, and the display apparatus according to the invention are designed to be a proper structure shape coordinating with gravity such that the whole efficiency of heat dissipation thereof significantly improves better than that of a heat-dissipating structure in the prior art, which solves the difficulty in facing the choice between the cost and the efficiency.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic drawing illustrating a heat-dissipating structure according to a preferred embodiment of the invention.

FIG. 2 is a schematic drawing illustrating the heat-dissipating structure in FIG. 1 with the included angle of the heat pipe larger than 90 degrees.

FIG. 3 is a schematic drawing illustrating a heat-dissipating structure according to another preferred embodiment of the invention.

FIG. 4 is a schematic drawing illustrating a heat-dissipating structure according to another preferred embodiment of the invention.

FIG. 5 is a schematic drawing illustrating a heat-dissipating structure according to another preferred embodiment of the invention.

FIG. 6 is a schematic drawing illustrating the heat-dissipating structure in FIG. 5 with the included angle of the heat pipe larger than 90 degrees.

FIG. 7 is a schematic drawing illustrating the heat-dissipating structure in FIG. 5 with the included angle of the heat pipe smaller than 90 degrees.

FIG. 8 is a schematic drawing illustrating the heat-dissipating structure in FIG. 5 using the heat pipes in FIG. 1.

FIG. 9 is a partial sectional drawing of a backlight module according to a preferred embodiment of the invention.

FIG. 10 is a partial sectional drawing of a backlight module according to another preferred embodiment of the invention.

FIG. 11 is a partial sectional drawing of a backlight module according to another preferred embodiment of the invention.

FIG. 12 is a schematic drawing illustrating a display apparatus according to a preferred embodiment of the invention.

### DETAILED DESCRIPTION

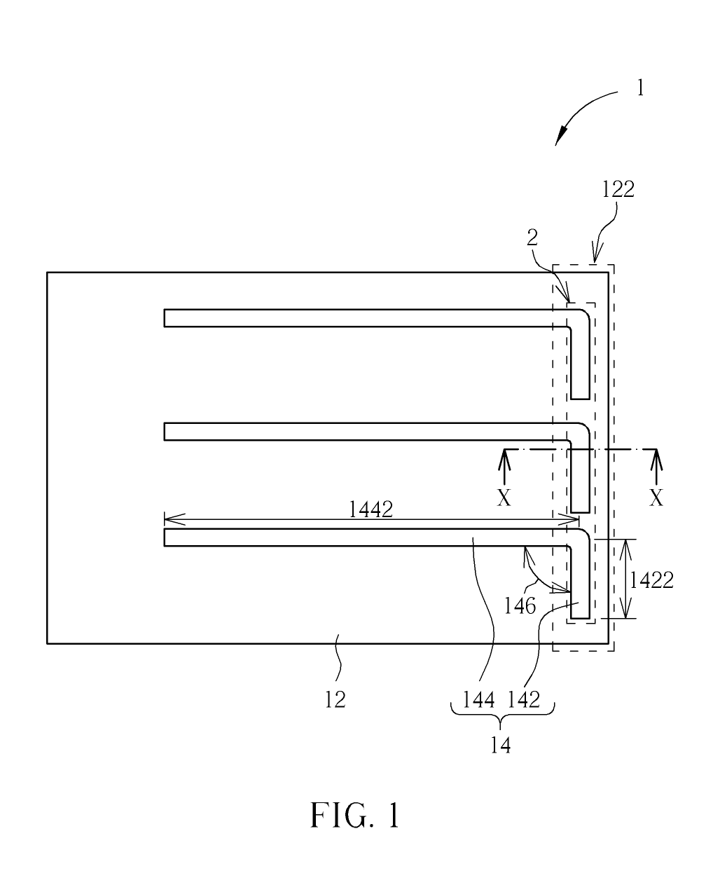

Please refer to FIG. 1, which is a schematic drawing illustrating a heat-dissipating structure according to a preferred embodiment of the invention. The heat-dissipating structure 1 is used in a backlight module for dissipating heat produced in operation by a light source module 2 (shown by dashed lines in the figure) of the backlight module. The heat-dissipating structure 1 includes a back plate 12 and three heat pipes 14 (only one labeled). Each heat pipe 14 is coupled to the back plate 12 and includes a heat-absorbing portion 142 and a heat-dissipating portion 144. The heat-absorbing portion 142 is disposed at a side portion 122 (the range of which is designated by dashed lines) of the back plate 12. The heat-dissipating portion 144 is bent upward from the heat-absorbing portion 142 to extend toward a center portion of the back plate 12. The light source module 2 is disposed simultaneously on each heat-absorbing portion 142.

The heat-dissipating structure 1 stands to be used during operation. The back plate 12 and a horizontal plane substantially form an included angle, ranging from 60 to 120 degrees. Thereby, working fluid in the heat pipe 14 can absorb heat produced in operation by the light source module 2 at the heat-absorbing portion 142, a lower position, to be a gas phase. Then, the working fluid moves to the heat-dissipating portion 144, a higher position, to emit the heat carried by the working fluid to be a liquid phase again. The position of the heat-dissipating portion 144 is relatively higher, so the working fluid in the liquid phase can flow with a gravity acceleration back to the heat-absorbing portion 142 through a capillary structure of the heat pipe 14 for a next heat absorption-and-dissipation cycle. Because the cycle is accelerated, the whole efficiency of heat dissipation is improved.

In the embodiment, the three heat pipes 14 are equivalent, but the invention is not limited to this. For example, the lengths of the heat-absorbing portion 142 and the heat-dissipating portion 144 and the total length of the heat pipe 14 can be modified by a design; besides, the disposition quantity for the heat pipe 14 can also be decided by a product specification so as to obtain more economical heat dissipation. In a practical product, it may include a plurality of heat pipes. In principle, if only one of the heat pipes complies with the requirements of the heat pipe 14 mentioned above, the heat pipes can effect an improvement of the efficiency of heat dissipation. In addition, in the embodiment, the heat-absorbing portion 142 and the heat-dissipating portion 144 are connected to substantially be L-shaped; in principle, a longitudinal length 1442 of the first heat-dissipating portion 144 is longer than a longitudinal length 1422 of the first heat-absorbing portion 142. In other words, for the heat pipe 14 in tubular structure, the tube length of the heat-dissipating portion 144 is longer than the tube length of the heat-absorbing portion 142, so the area for heat transfer of the heat-dissipating portion 144 is larger than that of the heat-absorbing portion 142 so that the working fluid in the gas phase can dissipate heat through a larger area. Moreover, the longer heat-dissipating portion 144 is conducive to a full utilization of the heat dissipation function of the back plate 12.

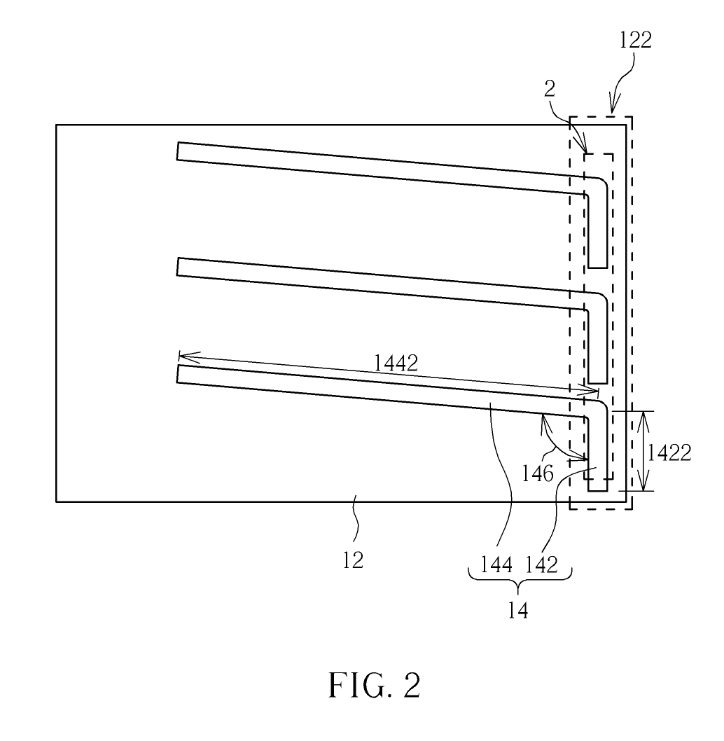

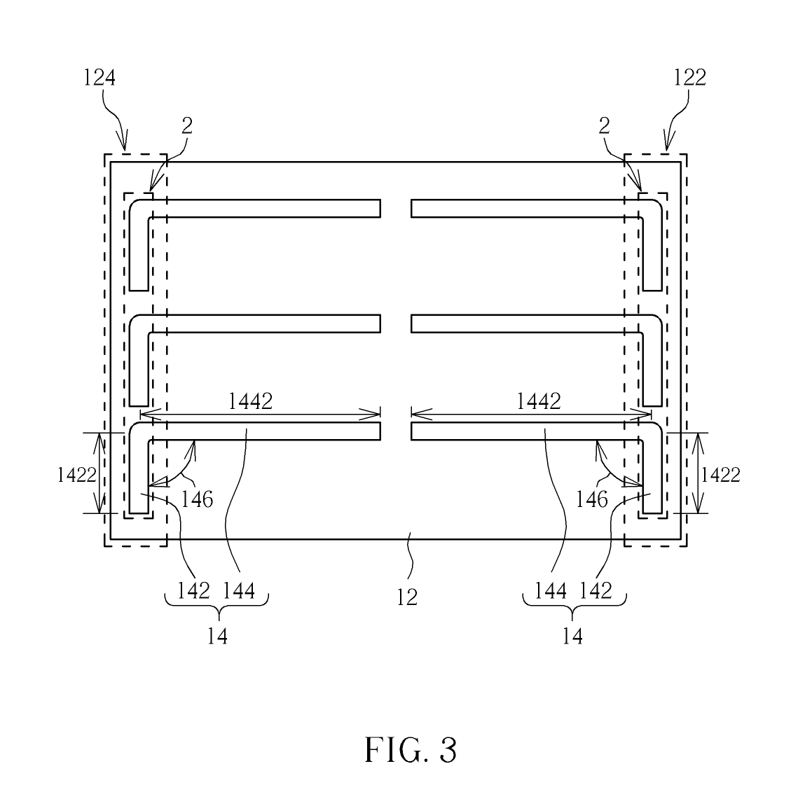

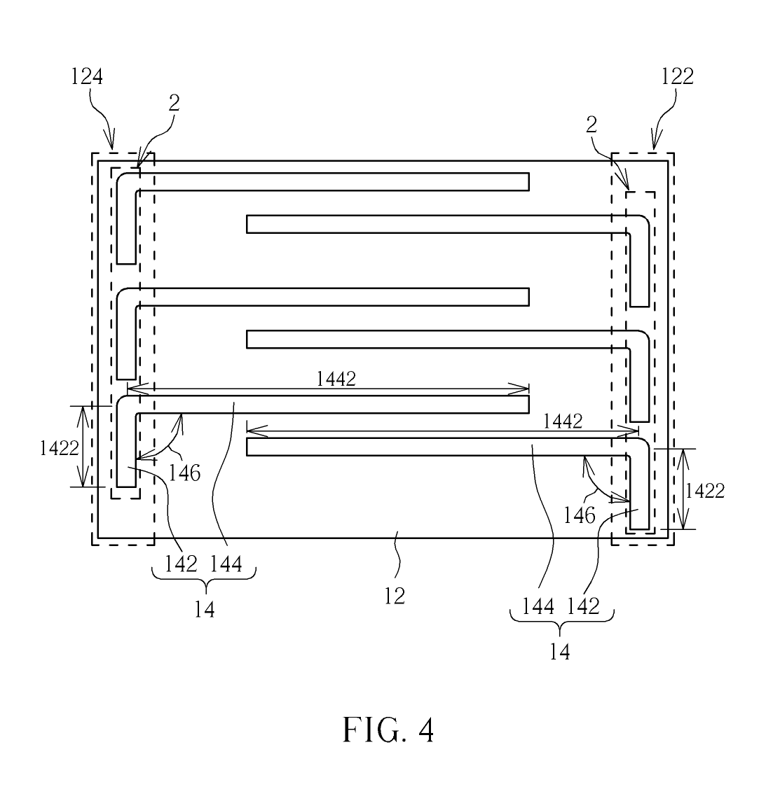

Furthermore, the extension direction of the heat-absorbing portion 142 and the extension direction of the heat-dissipating portion 144 form an included angle 146. For efficiently utilizing gravity, the included angle 146 is equal to or larger than 90 degrees in principle. As shown in FIG. 1, the included angle 146 is 90 degrees; as shown in FIG. 2, the included angle 146 is larger than 90 degrees. In practice, the setting for the included angle 146 may depend on the result of experiment on a practical product. In addition, that the heat-dissipating portion 144 extends toward the center portion of the back plate 12 does not mean extending only to the center portion. The length for the extension of the heat-dissipating portion 144 may depend on the requirements of product design. In the embodiment, the heat-dissipating structure 1 is used in the backlight module with a single-side light source; however, the invention is not limited to this. Please refer to FIG. 3, which is a schematic drawing illustrating a heat-dissipating structure according to another preferred embodiment of the invention. The heat-dissipating structure in FIG. 3 is used in a backlight module with a two-side light source, so compared with the heat-dissipating structure 1 in FIG. 1, the heat-dissipating structure in FIG. 3 additionally includes a plurality of heat pipes at another side portion 124 (opposite to the original side portion 122), which are equivalent in structure to the heat pipes 14 at the original side portion 122. As shown in FIG. 3, the two sets of the heat pipes 14 are disposed symmetrically, so the longitudinal length 1442 of the heat-dissipating portion 144 of the heat pipe 14 needs to be smaller than that of the heat-dissipating portion 144 of the heat pipe 14 in FIG. 1. In practice, the two sets of the heat pipes 14 can be staggered to be disposed. Please refer to FIG. 4, which is a schematic drawing illustrating a heat-dissipating structure according to another preferred embodiment of the invention. The difference between the heat-dissipating structure in FIG. 4 and the heat-dissipating structure in FIG. 3 is that the two sets of the heat pipes 14 of the heat-dissipating structure in FIG. 4 are staggered to be disposed. In this case, the longitudinal length 1442 of the heat-dissipating portion 144 of the heat pipe 14 in FIG. 4 can be longer than that of the heat-dissipating portion 144 of in FIG. 3. It is added that the included angle 146 in FIG. 3 and FIG. 4 is 90 degrees, but the abovementioned description of the included angle 146 can also be applied to the cases in FIG. 3 and FIG. 4, which is not to be described more.

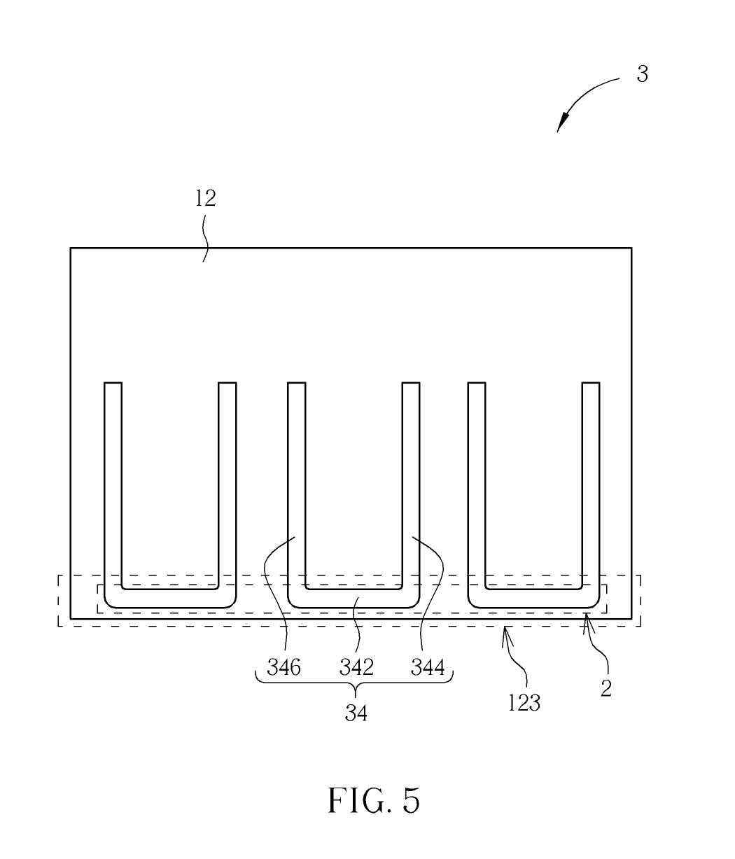

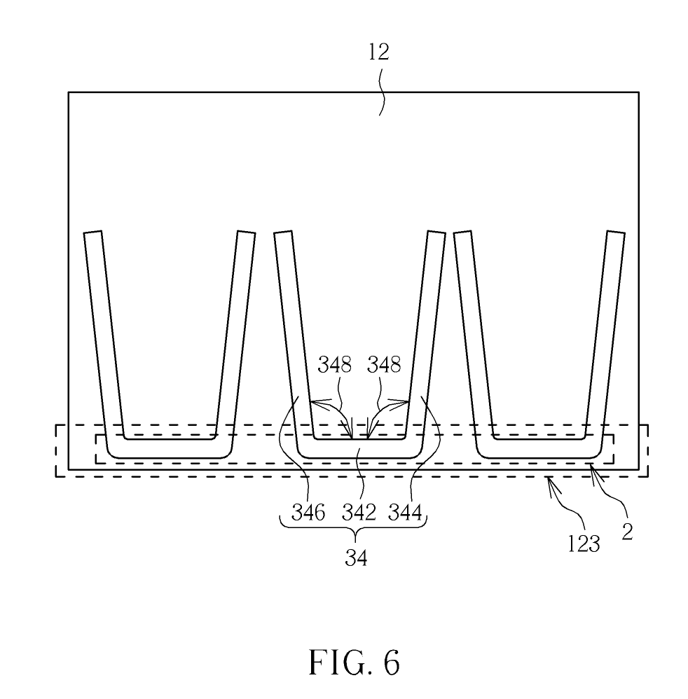

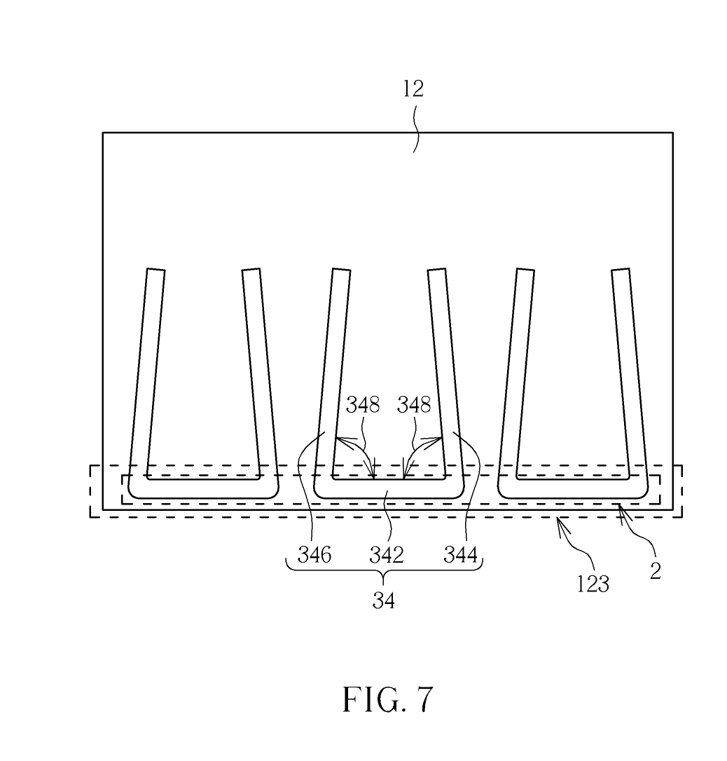

Please refer to FIG. 5, which is a schematic drawing illustrating a heat-dissipating structure according to another preferred embodiment of the invention. The main difference between the heat-dissipating structure 3 and the heat-dissipating structure 1 in FIG. 1 is the disposition and structure of the heat pipes. Each of heat pipes 34 (only one labeled) of the heat-dissipating structure 3 includes a heat-absorbing portion 342, a first heat-dissipating portion 344, and a second heat-dissipating portion 346. The heat-absorbing portion 342 is disposed at a lower side of the back plate 12. The first heat-dissipating portion 344 and the second heat-dissipating portion 346 are respectively connected to the heat-absorbing portion 342 and bent upward from the heat-absorbing portion 342 to extend toward the center portion of the back plate 12 so that the heat pipe 34 is U-shaped substantially. Similarly, working fluid in the heat pipe 34 can absorb heat produced in operation by the light source module 2 at the heat-absorbing portion 342, a lower position, to be a gas phase. Then, the working fluid moves to the first heat-dissipating portion 344 or the second heat-dissipating portion 346, a higher position, to emit the heat carried by the working fluid to be a liquid phase again. The liquid working fluid flows with a gravity acceleration back to the heat-absorbing portion 342 through a capillary structure of the heat pipe 34 for a next heat absorption-and-dissipation cycle. Compared with the heat pipe 14 of the heat-dissipating structure 1, the heat pipe 34 of the heat-dissipating structure 3 has two heat-dissipating portions 344 and 346, so the heat pipe 34 has a larger contact area for heat dissipation. Besides, the heat-dissipating portions 344 and 346 of the heat pipe 34 are substantially vertically disposed, which is conducive to full utilization of gravity so that the back flow velocity of the working fluid in the heat pipe 34 is obviously higher than that of the working fluid in the heat pipe 14. However, the invention does not exclude the cases in which the heat-dissipating portions 344 and 346 are not disposed vertically. As shown in FIG. 6, the heat-dissipating structure in FIG. 6 is equivalent in structure to the heat-dissipating structure 3 in FIG. 5, but the included angles 348 between the heat-absorbing portion 342 and the heat-dissipating portions 344 and 346 respectively of the heat pipe 34 are larger than 90 degrees. Besides, as shown in FIG. 7, the heat-dissipating structure in FIG. 7 is equivalent in structure to the heat-dissipating structure 3 in FIG. 5, but the included angles 348 between the heat-absorbing portion 342 and the heat-dissipating portions 344 and 346 respectively of the heat pipe 34 are smaller than 90 degrees.

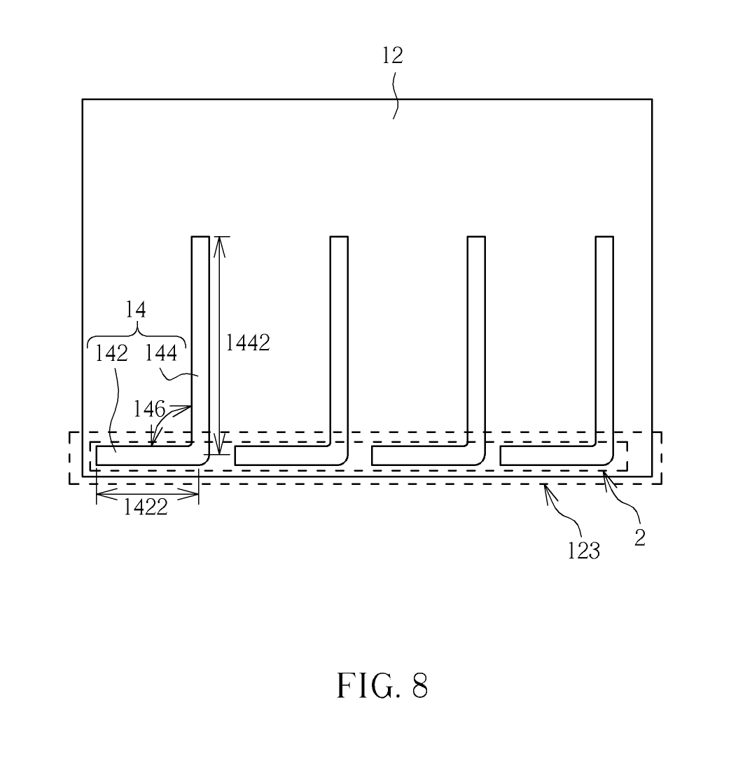

It is added that the determination for the disposition positions of the heat-absorbing portion 342 and the heat-absorbing portion 142 (referring to the heat-dissipating structure 1 in FIG. 1) depends on the disposition position of the light source module 2 used in the applied backlight module; however, the invention is not limited to the embodiments above. Furthermore, the heat pipe 34 of the heat-dissipating structure 3 can be shaped as the heat pipe 14 of the heat-dissipating structure 1 to also obtain a better efficiency of heat dissipation than that of the heat-dissipating structure, as shown in FIG. 8. In addition, in FIG. 8, although the heat pipe 14 has only one heat-absorbing portion 142 and one heat-dissipating portion, the abovementioned description of the included angles 348 between the heat-absorbing portion 342 and the heat-dissipating portions 344 and 346 respectively can also be applied to the included angle 146 of the heat-absorbing portion 142 and the heat-dissipating portion 144, which is not to be described more.

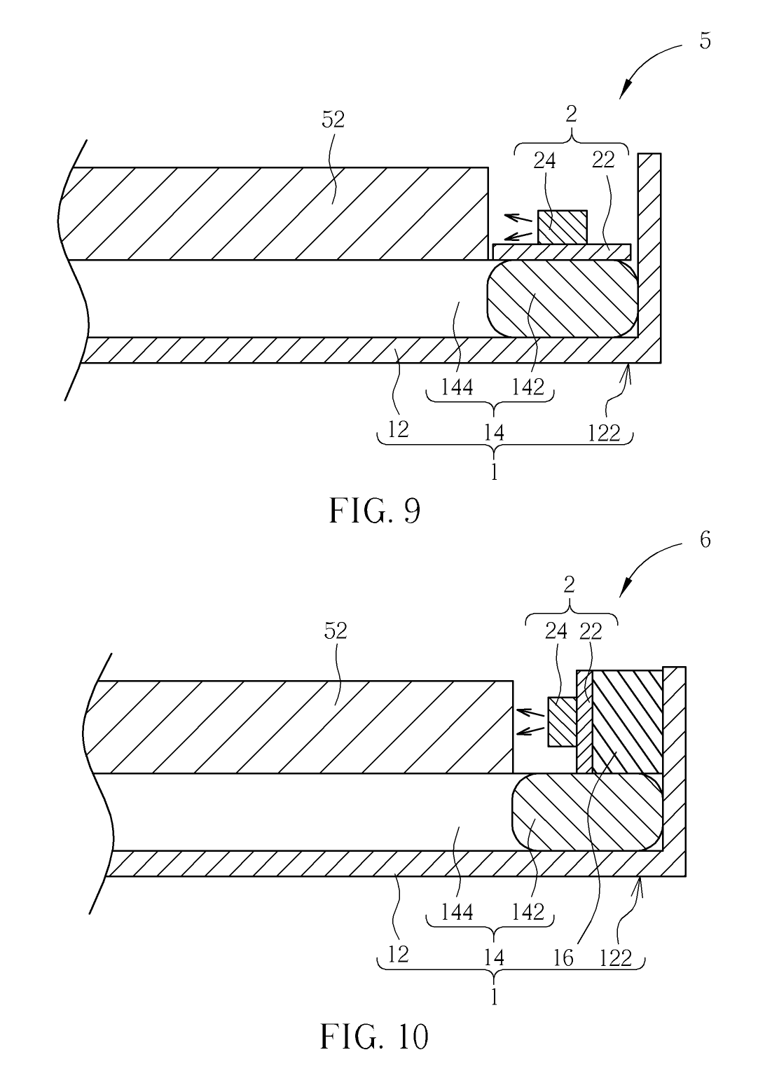

Please refer to FIG. 1 and FIG. 9. FIG. 9 is a partial sectional drawing of a backlight module of according to a preferred embodiment of the invention, wherein please refer to the line X-X in FIG. 1 for the position of the cut surface. In the embodiment shown in FIG. 9, the backlight module 5 includes the heat-dissipating structure 1, the light source module 2, and a light-guiding plate 52. The description of the heat-dissipating structure 1 has been explained in the foregoing and is not to be described more. The light source module 2 is disposed on the heat-absorbing portions 142 of the heat pipes 14. The light source module 2 includes a substrate 22 and a plurality of LEDs 24 disposed on the substrate 22. In the embodiment, the LED 24 is a side view LED. The substrate 22 can be a print circuit board (PCB), such as metal core PCB which is conducive to heat conduction. The light-guiding plate 52 is disposed above the back plate 12 and the heat pipes 14. The light source module 2 is disposed at a side of the light-guiding plate 52 so that light (shown by arrows) emitted by the LED 24 travels from the side into the light-guiding plate 52. For the description of the standing use and heat transfer of the heat-dissipating structure 1, please refer to the related description mentioned above, which is not to be described more.

Please refer to FIG. 9 and FIG. 10. FIG. 10 is a partial sectional drawing of a backlight module according to another preferred embodiment of the invention. The main difference from the backlight module 5 is that the heat-dissipating structure 1 of the backlight module 6 additionally includes a heat sink 16 disposed on the heat-absorbing portions 142 to be coupled to the light source module 2 and the heat-absorbing portions 142. The geometric size of the heat sink 16 coordinates with the substrate 22 of the light source module 2 to be designed to be a single long slab which may be cut into sections coordinating with the heat-absorbing portions 142; however, the invention is not limited to this. It is added that a heat source (i.e. the light source module 2) directly contacts the heat-absorbing portion 142 for a better efficiency of heat dissipation in principle. However, for different emitting directions of LEDs, for example the LED 24 of the backlight module 6 which is a top view LED, the substrate 22 may not directly, fully contacts the heat-absorbing portion 142, so a heat sink (i.e. the heat sink 16) is additionally taken as a main medium for heat transfer; therein, a side of the substrate 22 still can contact the heat-absorbing portion 142, which is conducive to heat transfer.

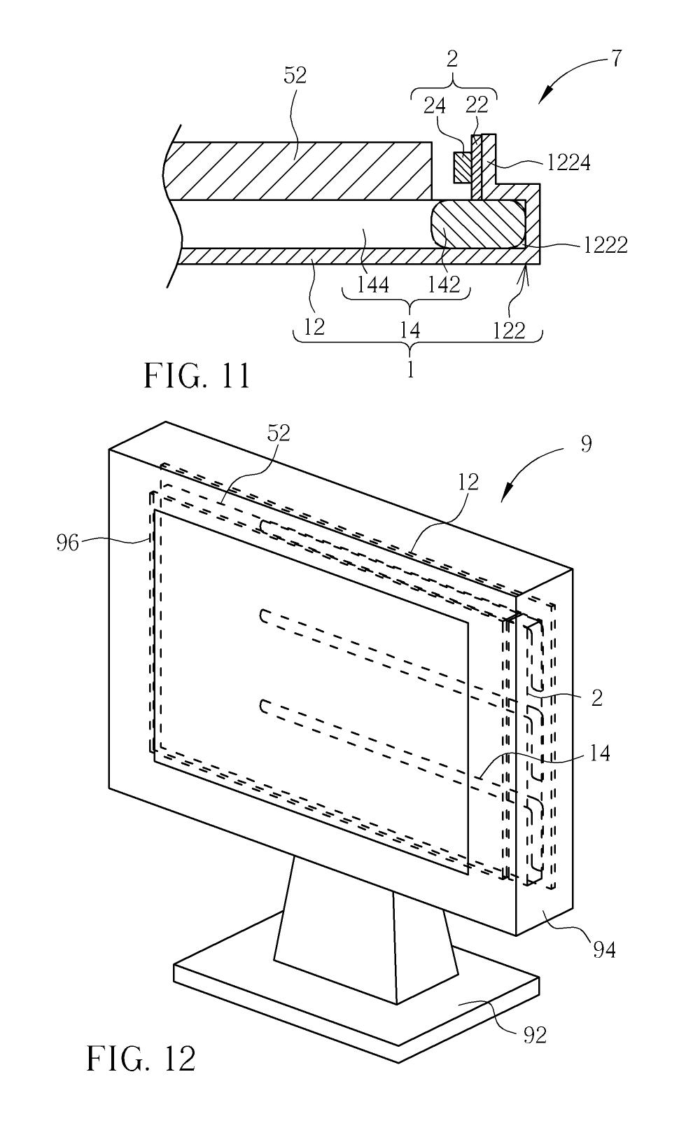

Please refer to FIG. 10 and FIG. 11. FIG. 11 is a partial sectional drawing of a backlight module according to another preferred embodiment of the invention. The main difference from the backlight module 6 is that the heat-dissipating structure 1 of the backlight module 7 does not use the heat sink 16 but is to bend the side portion 122 of the back plate 12 to form a recess 1222 and a fringe portion 1224. The heat-absorbing portion 142 is partially disposed in the recess; the fringe portion 1224 is coupled to the light source module 2. In the embodiment, two sidewalls of the recess 1222 clamp at least a portion of the heat-absorbing portion 142 in principle, so that heat absorbed from the substrate 22 by the fringe portion 1224 can also be transferred to the heat-dissipating portion 142. The design utilize apart of back plate 12 to be the main medium for heat transfer, and the heat sink 16 of the backlight module 6 is therefore eliminated.

It is added that although the heat-dissipating structure 1 is used in the backlight modules 5, 6 and 7 for examples, the backlight modules 5, 6 and 7 can use the heat-dissipating structures in the other embodiments in practice. The description of the variants of the heat-dissipating structure 1 is also applied to the other heat-dissipating structures in other embodiments, which is not to be described more. In addition, the coupling between components can be filled with a heat-conducting gel or slice, such as between the substrate 22 and the heat-absorbing portion 142, between the substrate 22 and the heat sink 16, between the heat-absorbing portion 142 and the sidewalls of the recess 1222, and so on, for eliminating the problem of uneven contact surface to improve the efficiency of heat conduction. It can also be applied to the foregoing embodiments and is not to be described additionally.

Therefore, the backlight modules 5, 6 and 7 equipped with the heat-dissipating structure according to the invention can have a better efficiency of heat dissipation than that of a conventional backlight module in the prior art. The efficient heat dissipation is conducive to reducing the junction temperature of the LED so as to extend its service life and to reducing the environment temperature so as to avoid the operation of other electronic components of the backlight module or other electronic components disposed nearby from the influence of the environment temperature.

Please refer to FIG. 1, FIG. 9, and FIG. 12. FIG. 12 is a schematic drawing illustrating a display apparatus of according to a preferred embodiment of the invention. The display apparatus 9 includes a base 92, a casing 94, a panel 96, and the above-mentioned backlight module 5. The casing 94 is connected to the base 92. The panel 96, the backlight module 5, and other electronic components are disposed inside the casing 94. The back plate 12 of the heat-dissipating structure 1 of the backlight module 5 can be disposed directly on the base 92 or be mounted on the casing 94 to be equivalently disposed on the base 92. The panel 96 is disposed above the light-guiding plate 52 of the backlight module 5. For the description of the backlight module 5, please refer to the related description in the abovementioned embodiments, which is not to be described more. In principle, the base 92 is disposed on a horizontal plane for use, such as on a table, the ground and so on, so that the back plate 12 can be used in a standing state. For the relation description of the included angle between the back plate 12 and the horizontal plane, please refer to the related description of the heat-dissipating structure 1 mentioned above. In practice, the base 92 can be designed to be a fixed frame, for example fixed on a wall, so that the back plate 12 can be used in a standing state.

Similarly, the display apparatus 9 equipped with the heat-dissipating structure 1 also has a good efficiency of heat dissipation, so that the whole operation stability and service life of the display apparatus 9 are longer than that of a display apparatus using a conventional heat-dissipating structure. Furthermore, the display apparatus according to the invention is not limited to the display apparatus 9. In practice, the display apparatus can use the heat-dissipating structures of the other embodiments mentioned above, the backlight modules 5, 6 and 7, or other variants based on the foregoing description. Therefore, the heat pipes of the heat-dissipating structure, the backlight module, and the display apparatus according to the invention are designed in structure for coordinating with gravity such that the whole efficiency of heat dissipation thereof significantly improves better than that of a heat-dissipating structure in the prior art, which solves the difficulty in facing the choice between the cost and the efficiency.

Those skilled in the art will readily observe that numerous modifications and alterations of the device and method may be made while retaining the teachings of the invention.

What is claimed is:

1. A heat-dissipating structure for standing use, for a backlight module including a light source module, the heat-dissipating structure comprising:
a back plate; and
a first heat pipe, coupled to the back plate, the first heat pipe comprising a first heat-absorbing portion and a first heat-dissipating portion, the first heat-absorbing portion being disposed at a side portion of the back plate, the first heat-dissipating portion being bent upward from the first heat-absorbing portion to extend toward a center portion of the back plate, wherein the light source module is disposed on the first heat-absorbing portion.

2. The heat-dissipating structure of claim 1, wherein the back plate and a horizontal plane substantially form an included angle of 60 to 120 degrees.

3. The heat-dissipating structure of claim 1, wherein the first heat-absorbing portion and the first heat-dissipating portion are connected to be substantially L-shaped, and a longitudinal length of the first heat-dissipating portion is longer than a longitudinal length of the first heat-absorbing portion.

4. The heat-dissipating structure of claim 1, wherein the side portion is at a lower side of the back plate, and the first heat pipe comprises a second heat-dissipating portion, bent upward from the first heat-absorbing portion to extend toward the center portion of the back plate.

5. The heat-dissipating structure of claim 1, further comprising a heat sink, disposed on the first heat-absorbing portion to be coupled to the light source module and the first heat-absorbing portion simultaneously.

6. The heat-dissipating structure of claim 1, wherein the side portion of the back plate is bent to form a recess and a fringe portion, at least a portion of the first heat-absorbing portion is disposed in the recess, and the fringe portion is coupled to the light source module.

7. The heat-dissipating structure of claim 1, further comprising a second heat pipe, coupled to the back plate, the second heat pipe comprising a second heat-absorbing portion and a third heat-dissipating portion, the second heat-absorbing portion being disposed at the side portion, the third heat-dissipating portion being bent upward from the second heat-absorbing portion to extend toward the center portion of the back plate, wherein the light source module is disposed on the first heat-absorbing portion and the second heat-absorbing portion simultaneously.

8. A backlight module for standing use, comprising:
a back plate;
a first heat pipe, coupled to the back plate, the first heat pipe comprising a first heat-absorbing portion and a first heat-dissipating portion, the first heat-absorbing portion being disposed at a side portion of the back plate, the first heat-dissipating portion being bent upward from the first heat-absorbing portion to extend toward a center portion of the back plate;
a light-guiding plate, disposed above the back plate and the first heat pipe; and
a light source module, disposed on the first heat-absorbing portion at a side of the light-guiding plate.

9. The backlight module of claim 8, wherein the back plate and a horizontal plane substantially form an included angle of 60 to 120 degrees.

10. The backlight module of claim 8, wherein the first heat-absorbing portion and the first heat-dissipating portion are connected to be substantially L-shaped, and a longitudinal length of the first heat-dissipating portion is longer than a longitudinal length of the first heat-absorbing portion.

11. The backlight module of claim 8, wherein the side portion is at a lower side of the back plate.

12. The backlight module of claim 11, wherein the first heat pipe further comprises a second heat-dissipating portion, bent upward from the first heat-absorbing portion to extend toward the center portion of the back plate, and the first heat-dissipating portion, the second heat-dissipating portion and the first heat-absorbing portion are connected together to form a substantially U-shape.

13. The backlight module of claim 8, further comprising a heat sink, disposed on the first heat-absorbing portion to be coupled to the light source module and the first heat-absorbing portion simultaneously.

14. The backlight module of claim 8, wherein the side portion of the back plate is bent to form a recess and a fringe portion, at least a portion of the first heat-absorbing portion is disposed in the recess, and the fringe portion is coupled to the light source module.

15. A display apparatus, comprising:
a base;
a back plate, disposed on the base;
a first heat pipe, coupled to the back plate, the first heat pipe comprising a first heat-absorbing portion and a first heat-dissipating portion, the first heat-absorbing portion being disposed at a side portion of the back plate, the first heat-dissipating portion being bent upward from the first heat-absorbing portion to extend toward a center portion of the back plate;
a light-guiding plate, disposed above the back plate and the first heat pipe;
a light source module, disposed on the first heat-absorbing portion at a side of the light-guiding plate; and
a panel, disposed above the light-guiding plate.

16. The display apparatus of claim 15, wherein the base is disposed on a horizontal plane, and the back plate and the horizontal plane substantially form an included angle of 60 to 120 degrees.

17. The display apparatus of claim 15, wherein the first heat-absorbing portion and the first heat-dissipating portion are connected to be substantially L-shaped, and a longitudinal length of the first heat-dissipating portion is longer than a longitudinal length of the first heat-absorbing portion.

18. The display apparatus of claim 15, wherein the side portion is at a lower side of the back plate, the first heat pipe further comprises a second heat-dissipating portion, bent upward from the first heat-absorbing portion to extend toward the center portion of the back plate, and the first heat-dissipating portion, the second heat-dissipating portion and the first heat-absorbing portion are connected together to form a substantially U-shape.

19. The display apparatus of claim 15, further comprising a heat sink, disposed on the first heat-absorbing portion to be coupled to the light source module and the first heat-absorbing portion simultaneously.

20. The display apparatus of claim 15, wherein the side portion is bent to form a recess and a fringe portion, at least a portion of the first heat-absorbing portion is disposed in the recess, and the fringe portion is coupled to the light source module.
